(19) United States
(12) Patent Application Publication
(10) Pub. No.: US 2026/0119047 A1
(43) Pub. Date: Apr. 30, 2026

(54) METHOD AND APPARATUS FOR PROCESSING ABNORMAL POWER FAILURE, DEVICE, MEDIUM, AND PRODUCT

(71) Applicant: SUZHOU METABRAIN INTELLIGENT TECHNOLOGY CO., LTD., Suzhou, Jiangsu (CN)

(72) Inventors: Qinglu CHEN, Suzhou, Jiangsu (CN); Baolin ZHAO, Suzhou, Jiangsu (CN); Wenzheng QIN, Suzhou, Jiangsu (CN)

(21) Appl. No.: 19/469,302

(22) PCT Filed: Nov. 22, 2024
(86) PCT No.: PCT/CN2024/133961

§ 371 Date: Sep. 25, 2025

(30) Foreign Application Priority Data
Mar. 19, 2024 (CN) 202410313486.8

(51) Int. Cl. G06F 3/06; G06F 1/30

(52) U.S. Cl. CPC G06F 3/0614; G06F 1/30; G06F 3/064; G06F 3/0653; G06F 3/0679

(57) ABSTRACT

A method for processing an abnormal power failure includes: in response to the abnormal power failure occurring during a process of executing low-level formatting by a solid-state drive, saving a value of a low-level formatting state in a low-level formatting flow at a moment of the abnormal power failure; during a process of powering on and executing driver loading, detecting the value of the low-level formatting state by each module of the solid-state drive; in response to the value of the low-level formatting state at the moment of the abnormal power failure indicating that: a log manager module is executing or completing the low-level formatting flow, not continuing to complete the low-level formatting flow corresponding to the log manager module.

### CROSS-REFERENCE TO RELATED APPLICATION

This application claims the priority of the Chinese Patent application filed on Mar. 19, 2024 before the CNIPA, China National Intellectual Property Administration with the application number of 202410313486.8, and the title of “METHOD AND APPARATUS FOR PROCESSING ABNORMAL POWER FAILURE, DEVICE, MEDIUM, AND PRODUCT”, which is incorporated herein in its entirety by reference.

### FIELD

The present application relates to the field of storage technology and more particularly, to a method and apparatus for processing an abnormal power failure, a device, a medium, and a product.

### BACKGROUND

When an abnormal power failure occurs, the built-in energy storage capacitor in solid state drives (SSDs) will continue to supply power to the SSD. Before the energy storage capacitor is depleted, it will program a write cache buffer that is not yet full and all the metadata in a double data rate SDRAM (DDR) to a computer flash memory device (Nand flash). The energy storage capacitor may generally provide continuous power supply for 50-100 ms. In order to ensure that a power down process of the above-mentioned solid-state drive may be completely processed during the abnormal power failure process, any scenario needs to consider the scenario of the abnormal power failure. Otherwise, if it fails to process the abnormal power down process of the solid-state drive, there will be data loss, and it may not be able to load and use normally when powered on again.

When the solid-state drive experiences the abnormal power failure during the low-level formatting flow, the low-level formatting flow will be interrupted and give way to the handling of the abnormal power failure process. However, because the low-level formatting flow is a complex flow that involves a L2P table (Logical To Physical Table, a mapping table from a logical block to a physical block) in the DDR, as well as the erasure of data in the computer flash memory devices, different low-level formatting flow may affect the recovery time of a power on process of the solid-state drive, and cannot directly exhibit a formatted effect after powering on and executing driver loading on the solid-state drive, which affects the read and write performance of the solid-state drive.

### SUMMARY

In view of this, the present application provides a method and apparatus for processing an abnormal power failure, a device, a medium, and a product.

The first aspect of the embodiment of the present application provides a method for processing an abnormal power failure, and the method includes:
in response to the abnormal power failure occurring during a process of executing low-level formatting by a solid-state drive, saving a value of a low-level formatting state in a low-level formatting flow at a moment of the abnormal power failure;
during a process of powering on the solid-state drive and executing driver loading by the solid-state drive, detecting the value of the low-level formatting state by each module of the solid-state drive;
in response to the value of the low-level formatting state at the moment of the abnormal power failure indicating that: a log manager module is executing or completing the low-level formatting flow, not continuing to complete the low-level formatting flow corresponding to the log manager module.

In an embodiment, further including:
creating a first block before the solid-state drive executes the low-level formatting;
listing and saving values of a plurality of low-level formatting states included in the low-level formatting flow in the first block, wherein a value of each of the plurality of low-level formatting states is configured to indicate a processing state of each module during recording and executing the low-level formatting flow.

In an embodiment, the values of the plurality of low-level formatting states are configured to indicate any one of the following states: a low-level formatting idle state, a state of erasing information related to a L2P table and a trim table in a first-level table, a completion state of erasing the information related to the L2P table and the trim table in the first-level table, a state of saving the first-level table, a completion state of saving the first-level table, a state of erasing a target block, a completion state of erasing the target block, a state of erasing the L2P table and the trim table, a completion state of erasing the L2P table and the trim table, a low-level formatting completed state.

In an embodiment, the solid-state drive at least includes a log manager module, a write manager module, and a data manager module; before in response to the value of the low-level formatting state at the moment of the abnormal power failure indicating that: a log manager module is executing or completing the low-level formatting flow, not continuing to complete the low-level formatting flow corresponding to the log manager module, the method further includes:
during the process of executing the driver loading by the solid-state drive, determining, by each module, whether to continue to complete a process of low-level formatting corresponding to each module based on the value of the low-level formatting state, to enable the solid-state drive to exhibit an effect produced by the low-level formatting;
in response to the value of the low-level formatting state at the moment of the abnormal power failure indicating that: the write manager module is executing or completing the low-level formatting flow, continuing to complete the low-level formatting flow corresponding to the write manager module; and
in response to the value of the low-level formatting state at the moment of the abnormal power failure indicating that: the data manager module is executing or completing the low-level formatting flow, not continuing to complete the low-level formatting flow corresponding to the data manager module.

In an embodiment, in response to the value of the low-level formatting state at the moment of the abnormal power failure indicating that: the log manager module is executing or completing the low-level formatting flow, not continuing to complete the low-level formatting flow corresponding to the log manager module, includes:
by the log manager module, receiving a request to execute the driver loading and detecting the value of the low-level formatting state in the low-level formatting flow;
in response to detecting that the value of the low-level formatting state in the low-level formatting flow at the moment of the abnormal power failure indicates: the state of erasing the information related to the L2P table and the trim table in the first-level table or the state of saving the first-level table, not executing a process of restoring the L2P table and the trim table in a power on recovery process of the solid-state drive, normally executing driver loading of the log manager module, setting the value of the low-level formatting state to indicate the completion state of saving the first-level table, and feeding back formatting completion information of the log manager module to a write manager module of the solid-state drive, so that the write manager module of the solid-state drive continues to complete a corresponding low-level formatting process thereof, to enable the solid-state drive to exhibit an effect produced by the low-level formatting;
in response to detecting that the value of the low-level formatting state in the low-level formatting flow at the moment of the abnormal power failure indicates: other states except for the completion state of erasing the information related to the L2P table and the trim table in the first-level table or the completion state of saving the first-level table, normally executing the driver loading of the log manager module, and directly feeding back the formatting completion information of the log manager module to the write manager module of the solid-state drive, so that the write manager module of the solid-state drive continues to complete the corresponding low-level formatting process thereof, to enable the solid-state drive to exhibit the effect produced by the low-level formatting.

In an embodiment, after feeding back the formatting completion information of the log manager module to the write manager module of the solid-state drive, the method further includes:
by the write manager module, receiving the formatting completion information of the log manager module feedback from the log manager module;
detecting the value of the low-level formatting state in the low-level formatting flow at the moment of the abnormal power failure;
in response to detecting that the value of the low-level formatting state in the low-level formatting flow at the moment of the abnormal power failure indicates: the completion state of saving the first-level table or the state of erasing the target block, erasing the target block in the solid-state drive, and resetting metadata related to the target block;
updating the value of the low-level formatting state to indicate the completion state of erasing the target block, feeding back formatting completion information of the write manager module to a data manager module of the solid-state drive;
in response to detecting that the value of the low-level formatting state in the low-level formatting flow at the moment of the abnormal power failure indicates: other states except for the completion state of saving the first-level table or the state of erasing the target block, normally executing driver loading of the write manager module, and feeding back the formatting completion information of the write manager module to the data manager module of the solid-state drive.

In an embodiment, after feeding back the formatting completion information of the write manager module to the data manager module of the solid-state drive, the method further includes:
by the data manager module, receiving the formatting completion information of the write manager module feedback from the write manager module, and detecting the value of the low-level formatting state in the low-level formatting flow at the moment of the abnormal power failure;
in response to detecting that the value of the low-level formatting state in the low-level formatting flow at the moment of the abnormal power failure indicates: the state of erasing the L2P table and the trim table, the completion state of erasing the L2P table and the trim table, the low-level formatting completed state or the completion state of erasing the target block, updating the value of the low-level formatting state to indicate the low-level formatting idle state, normally executing driver loading of the data manager module, and feeding back formatting completion information of the data manager module to a host.

In an embodiment, further including:
after the host receives the formatting completion information of the data manager module, determining that the low-level formatting is completed;
in response to the solid-state drive experiencing no abnormal power failure, completing the effect of the low-level formatting by the data manager module and the write manager module;
in response to the solid-state drive experiencing the abnormal power failure and is powered on again, completing the effect of the low-level formatting by the log manager module.

In an embodiment, in response to the abnormal power failure occurring during the process of executing the low-level formatting by the solid-state drive, saving the value of the low-level formatting state in the low-level formatting flow at the moment of the abnormal power failure, includes:
updating the value of the low-level formatting state in real-time during the process of executing the low-level formatting by each module of the solid-state drive;
in response to the abnormal power failure occurring during the process of executing the low-level formatting, saving a latest updated value of the low-level formatting state in the solid-state drive.

In an embodiment, further including:
adding detection of the abnormal power failure in response to each module of the solid-state drive executing the low-level formatting flow;
in response to the abnormal power failure occurring, exiting, by each module, the low-level formatting flow currently being processed, and executing power down process of the solid-state drive.

In an embodiment, in response to the abnormal power failure occurring during the process of executing the low-level formatting by the solid-state drive, saving the value of the low-level formatting state in the low-level formatting flow at the moment of the abnormal power failure, includes:
calling a built-in energy-storage capacitor in the solid-state drive;
in response to the built-in energy-storage capacitor supplying power to the solid-state drive, programming the value of the low-level formatting state in the low-level formatting flow at the moment of the abnormal power failure into a computer flash memory device of the solid-state drive.

The second aspect of the embodiment of the present application provides an apparatus for processing an abnormal power failure, including:
a save module configured for, in response to the abnormal power failure occurring during a process of executing low-level formatting by a solid-state drive, saving a value of a low-level formatting state in a low-level formatting flow at a moment of the abnormal power failure;
a detection module configured for, during a process of powering on the solid-state drive and executing driver loading by the solid-state drive, detecting the value of the low-level formatting state by each module of the solid-state drive;
a first execution module configured for, in response to the value of the low-level formatting state at the moment of the abnormal power failure indicating that: a log manager module is executing or completing the low-level formatting flow, not continuing to complete the low-level formatting flow corresponding to the log manager module.

The third aspect of the embodiment of the present application provides an electronic device, including a memory, a processor, and a computer program stored on the memory, wherein the processor executes the computer program to implement the method for processing the abnormal power failure of the first aspect.

The fourth aspect of the embodiment of the present application provides a computer program product, including a computer program, wherein the computer program, when executed by a processor, implements the method for processing the abnormal power failure of the first aspect.

The fifth aspect of the embodiment of the present application provides a non-transitory computer-readable medium, storing a computer program thereon, wherein the computer program, when executed by a processor, implements the method for processing the abnormal power failure of the first aspect.

The beneficial effects of the present application are:

The embodiment of the present application provides a method and apparatus for processing an abnormal power failure, a device, a medium, and a product. When an abnormal power failure occurs during the process of executing the low-level formatting by a solid-state drive, a value of a low-level formatting state in a low-level formatting flow at a moment of the abnormal power failure may be saved. During the process of powering on the solid-state drive and executing driver loading by the solid-state drive, each module located inside the solid-state drive detects the saved value of the low-level formatting state. When the value of the low-level formatting state at the moment of the abnormal power failure indicates that: a log manager module is executing or completing the low-level formatting flow, it does not continue to complete the low-level formatting flow corresponding to the log manager module.

By saving the values of the low-level formatting states and detecting the saved values of the low-level formatting states during the process of powering on the solid-state drive and executing driver loading by the solid-state drive, the low-level formatting state at the moment of the abnormal power failure may be determined. When the value of the low-level formatting state at the moment of the abnormal power failure indicates that the log manager module is executing or completing the low-level formatting flow, the log manager module does not continue to complete the low-level formatting flow corresponding to the log manager module. During the process of powering on the solid-state drive and executing driver loading by the solid-state drive, when the saved value of the low-level formatting state indicates that the log manager module is executing or completing the low-level formatting flow, the log manager module does not continue to complete the low-level formatting flow corresponding to the log manager module, thereby reducing the recovery time of the power on process and further enabling the solid-state drive to exhibit an effect produced by the low-level formatting directly after being powered on and executing driver loading, thereby improving the read and write performance of the solid-state drive.

### BRIEF DESCRIPTION OF THE DRAWINGS

The accompanying drawings, which form a part of this application, are used to provide further understanding of the present application. The illustrative embodiments and their explanations of the present application are used to explain the present application and do not constitute undue limitation of the present application.

In order to more clearly illustrate the technical solution of the embodiments of the present application, a brief introduction will be given to the accompanying drawings required to be used in the description of the embodiments. It is obvious that the accompanying drawings described below are only some embodiments of the present application. For those skilled in the art, other drawings may be obtained based on these drawings without creative work.

FIG. 1 is a flow chart of a method for processing an abnormal power failure according to some embodiments of the present application;

FIG. 2 is a structural diagram of a solid-state drive according to some embodiments of the present application; and

FIG. 3 is a schematic diagram of a framework of an apparatus for processing an abnormal power failure according to some embodiments of the present application.

### DETAILED DESCRIPTION

It should be noted that the embodiments and features in the embodiments of the present application may be combined with each other in the absence of conflict.

Below, the technical solutions in the embodiments of the present application will be clearly and completely described in conjunction with the accompanying drawings of the embodiments of the present application. Obviously, the described embodiments are a part of the embodiments of the present application, not all of them. Based on the embodiments in the present application, all other embodiments obtained by persons skilled in the art without creative work are within the scope of protection of the present application.

Enterprise grade solid-state drives usually use a write cache mechanism, and the cache is a contiguous space in the solid-state drive memory. The read and write operations of computer flash memory devices are based on pages. A size of a typical SLC (Single-Level Cell) page is 16 KiB, and a size of a TLC (Trinary-Level Cell) page is 48 KiB. In this way, the solid-state drive receives user data and stores it in the cache (usually 4 KiB granularity) according to certain rules. When the total amount of user data reaches the preset upper limit (such as a preset integer multiple of the size of the TLC page), the user data stored in a block in the cache may be programed to the computer flash memory device.

In fact, the cache is a contiguous memory space that is divided into units of page size, and each unit may be regarded as a write cache buffer. In addition, the normal operation of the solid-state drives also requires the support of metadata, and the metadata is also the system data of the solid-state drives. During the operation of the solid-state drives, the metadata often resides in DDR, such as L2P tables. When the solid-state drive is being powered down, it needs to program the write cache buffer that has already stored user data but is not yet full, as well as all metadata in the DDR, to the computer flash memory device. When the solid-state drive is powered on again, the metadata needs to be read from the computer flash memory device and fully restored to the DDR.

The purpose of NVMe (non-volatile memory express, it is a specification for the solid-state drive using PCI-E channels) formatting operation is to erase user data on the solid-state drive and modify some configuration parameters (such as metadata) of the solid-state drive, distinguishing between high-level formatting and low-level formatting. The high-level formatting only needs to erase the L2P table without erasing user data on the computer flash memory device, with fast execution speed. The low-level formatting requires secure erasure of all user data on the solid-state drive, so not only will it erase the L2P table, but it will also erase all user data on the computer flash memory device and in the write cache buffer. The action of erasing the computer flash memory device is a long time-consuming operation that is related to the capacity of the solid-state drive and is usually S-level time-consuming.

When an abnormal power failure occurs, the built-in energy storage capacitor in solid state drives (SSDs) will continue to supply power to the SSD. Before the energy storage capacitor is depleted, it will program the write cache buffer that is not yet full and all the metadata in the double data rate SDRAM (DDR) to a computer flash memory device (Nand flash). The energy storage capacitor may generally provide continuous power supply for 50-100 ms. In order to ensure that a power down process of the above-mentioned solid-state drive may be completely processed during the abnormal power failure process, any scenario needs to consider the scenario of the abnormal power failure. Otherwise, if it fails to process the abnormal power down process of the solid-state drive, there will be data loss, and it may not be able to load and use normally when powered on again.

When the solid-state drive experiences the abnormal power failure during the low-level formatting flow, the low-level formatting flow will be interrupted and give way to the handling of the abnormal power failure process. However, because the low-level formatting flow is a complex flow that involves a L2P table (Logical To Physical Table, a mapping table from a logical block to a physical block) in the DDR, as well as the erasure of data in the computer flash memory devices, different low-level formatting flow may affect the recovery time of a power on process of the solid-state drive, and cannot directly exhibit a formatted effect after powering on and executing driver loading on the solid-state drive, which affects the read and write performance of the solid-state drive.

Based on this, the present application proposes a method for processing an abnormal power failure, which may solve the above-mentioned technical problems.

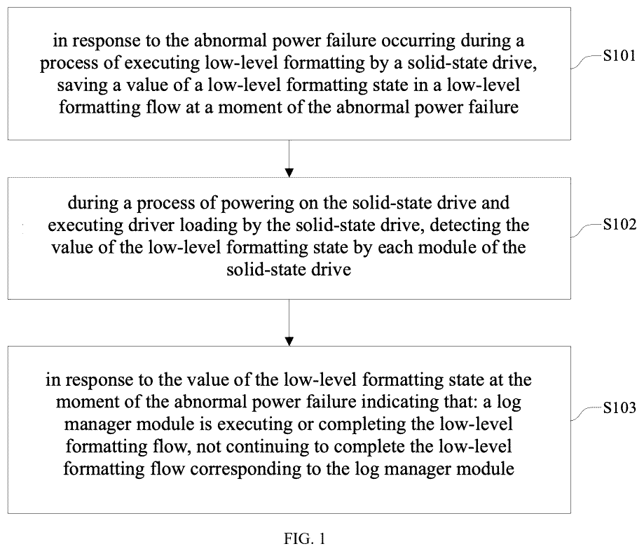

FIG. 1 is a flow chart of a method for processing an abnormal power failure according to some embodiments of the present application. As shown in FIG. 1, this embodiment provides a method for processing an abnormal power failure, which includes:
in step S101, in response to the abnormal power failure occurring during a process of executing low-level formatting by a solid-state drive, saving a value of a low-level formatting state in a low-level formatting flow at a moment of the abnormal power failure;
in step S102, during a process of powering on the solid-state drive and executing driver loading by the solid-state drive, detecting the value of the low-level formatting state by each module of the solid-state drive;
in step S103, in response to the value of the low-level formatting state at the moment of the abnormal power failure indicating that: a log manager module is executing or completing the low-level formatting flow, not continuing to complete the low-level formatting flow corresponding to the log manager module.

Firstly, in step S101, when the abnormal power failure occurs during the process of executing the low-level formatting by the solid-state drive, the value of the low-level formatting state in the low-level formatting flow at the moment of the abnormal power failure is saved. In the embodiment of the present application, the solid-state drive starts executing low-level formatting after receiving the low-level formatting flow sent by the host. The low-level formatting process includes multiple steps. When the abnormal power failure occurs during the process of executing the low-level formatting by the solid-state drive, the low-level formatting will be interrupted and gives way to the power down processing in the abnormal power failure process. At this time, the built-in energy storage capacitor of the solid-state drive supplies power to the solid-state drive, and the value of the low-level formatting state in the low-level formatting flow at the moment of the abnormal power failure is saved. The low-level formatting state is used to indicate which step the current low-level formatting process is executed to. The values of different low-level formatting states may be set in advance, the values of the low-level formatting state at the moment of the abnormal power failure are saved in the computer flash memory device of the solid-state drive, ensuring that the values of the low-level formatting state at the moment of the abnormal power failure will not be cleared.

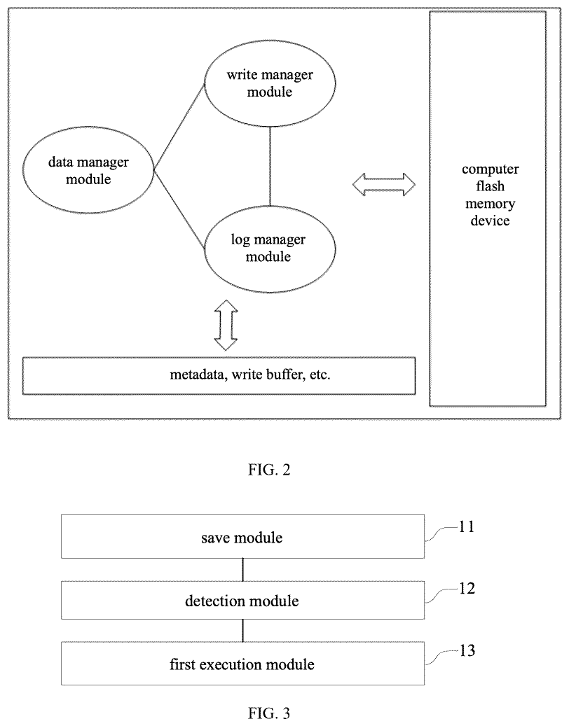

The following provides a detailed explanation of the various modules included in the solid-state drive and the various steps of the low-level formatting flow. FIG. 2 is a structural diagram of the solid-state drive provided in some embodiments of the present application. As shown in FIG. 2, the solid-state drive includes a log manager module (which may be a Journal Manager, and abbreviated as JM), a data manager module (which may be a Data Manager, and abbreviated as DM), a write manager module (which may be a Write Manager, and abbreviated as WM), and a computer flash memory device.

Among them, the data manager module is the front-end firmware core of the solid-state drive facing the host (running on the CPU hardware core), mainly responsible for responding to IO commands of the user data such as read and write commands sent by the host, as well as Admin commands such as formatting and power on/down. In the write process, the data manager module moves the user data from the host memory to the write cache buffer in the solid-state drive memory, and updates the content of the L2P table to the cache entry index Based on a LBA (Logical Block Address), among them, the index is equivalent to the sequence number of the write cache buffer. When the read process of the solid-state drive hits the cache, the corresponding write cache buffer may be found through the cache entry index in the L2P table, and the data in the buffer may be returned to the host.

The write manager module is responsible for programing data from the write cache buffer to the firmware core (running on the CPU hardware core) in the computer flash memory device. After the user data is programed to the computer flash memory device, the write manager module will update the cache entry index in the L2P table to the address of the computer flash memory device. When the solid-state drive reads data, it may search the L2P table based on LBA to obtain the address of the computer flash memory device, read the user data from the computer flash memory device, and return the user data to the host.

In addition, Because the write manager module is aimed at the computer flash memory devices, the write manager module is also responsible for managing the blocks of computer flash memory devices, including applying for free blocks and erasing used blocks. All block information is recorded in the target block information (Block info). The target block information (Block info) is also a type of metadata that resides in the DDR and is mainly updated and maintained by the write manager module.

The log manager module is responsible for managing the metadata of the solid-state drives, performing runtime saving and power-down saving of the metadata, as well as the power on recovery. Updating the L2P table by both the data manager module and the write manager module will cause changes to the L2P table, and notify the log manager module of the specific changes in the L2P table. The log manager module will use a runtime saving mechanism to program the L2P table. During the power-down execution process, the log manager module will save the metadata snapshots, such as the L2P tables that are generated by the runtime saving and have not been programed, in the computer flash memory device, usually taking less than 15 ms. When the solid-state drive is powered on again, the log manager module reads the metadata such as the L2P tables from the computer flash memory device and restores them to the DDR of the solid-state drive.

The various steps of the low-level formatting flow for the solid-state drives include:

Firstly, after receiving the low-level formatting flow sent by the host and transmitting it to the data manager module, the solid-state drive will clear the contents of the first-level table. The first-level table is a mapping table from JM_L2P, that is generated after the log manager module programs the L2P table and other metadata to the computer flash memory device in a 16k snapshot size, to the address of the computer flash memory device.

After the log manager module completes the formatting, it notifies the write manager module that the formatting is completed. Upon receiving the formatting completion message from the log manager module, the write manager module begins to erase all computer flash memory devices including the user data and notifies the log manager module to execute runtime saving of target block information (block info) changes.

After the write manager module completes erasing all computer flash memory devices including the user data, it notifies the data manager module that the formatting is completed. Upon receiving the formatting completion message from the write manager module, the data manager module begins to erase the metadata such as the L2P tables in the DDR After erasing is completed, the data manager module notifies the host that the entire formatting flow is completely executed and begins receiving new read and write requests.

Furthermore, in the step S102, during the process of powering on the solid-state drive and executing the driver loading by the solid-state drive, various modules of the solid-state drive detect the value of the low-level formatting state. In the embodiment of the present application, after saving the value of processing the low-level formatting state of the solid-state drive when processing the low-level formatting flow at the moment of the abnormal power failure, the solid-state drive is powered on again. At this time, the various modules included in the solid-state drive will execute the driver loading in sequence. During the process of executing the driver loading, the various modules of the solid-state drive will sequentially detect the saved value of the low-level formatting state at the moment of the abnormal power failure to determine which step the low-level formatting process is in at the moment of the abnormal power failure, and to determine whether the various modules have completed the corresponding low-level formatting step.

Finally, in the step 103, when the value of the low-level formatting state at the moment of the abnormal power failure indicates that: the log manager module is executing or completing the low-level formatting flow, it does not continue to complete the low-level formatting flow corresponding to the log manager module. In the embodiment of the present application, due to the abnormal power failure during the low-level formatting process, it needs to enable the low-level formatting flow to give way to the power-down process of the abnormal power failure, the power-down process will program the write cache buffer that is not yet full and all metadata in the DDR (including the L2P table, the trim table, etc.) to the computer flash memory device of the solid-state drive, the deleted metadata will be read from the computer flash memory device and fully restored to the DDR after powering on again. At this time, when powered on again, due to the introduction of the value of the low-level formatting state at the moment of the abnormal power failure, the low-level formatting flow being executed at the moment of the abnormal power failure may be determined when powered on again. Therefore, when the value of the low-level formatting state at the moment of the abnormal power failure indicates that: the log manager module is executing or completing the low-level formatting flow, the metadata (including the L2P table, the trim table, etc.) has been cleared, and the low-level formatting flow corresponding to the log manager module will not continue to be executed.

In some embodiments, if there is no low-level formatting, the log manager module relies on operations such as reading the first-level table first and then reading the computer flash memory device to restore the metadata such as the L2P table when powered on. At this point, the log manager module will clear the first-level table, including clearing the JM_L2P information related to the user data in the first-level table. After the solid-state drive formatting flow is completed, and due to the need to continue to execute the low-level formatting flow, the solid-state drive will be powered on again. Since the JM_L2P related to the user data has been cleared, the metadata such as the L2P table will no longer be restored during the power on process. The L2P table defaults to the initial zero value of the DDR.

Moreover, after the solid-state drive is powered down abnormally and then powered on again, the effect of the low-level formatting is completed by the log manager module. Since the log manager module no longer restores the metadata such as the L2P table to the DDR, when the solid-state drive is read again, because the L2P table is empty, only empty data may be returned to the user on the host side, thus achieving the formatting effect and improving the read-write performance of the solid-state drive.

Through the above embodiments, when the abnormal power failure occurs during the process of executing the low-level formatting by the solid-state drive, the value of the low-level formatting state in the low-level formatting flow at the moment of the abnormal power failure may be saved. During the process of powering on the solid-state drive and executing the driver loading by the solid-state drive, various modules located inside the solid-state drive detect the saved value of the low-level formatting state. When the value of the low-level formatting state at the moment of the abnormal power failure indicates that: the log manager module is executing or completing the low-level formatting flow, it does not continue to complete the low-level formatting flow corresponding to the log manager module.

By saving the values of the low-level formatting states and detecting the saved values of the low-level formatting states during the process of powering on the solid-state drive and executing the driver loading by the solid-state drive, the low-level formatting state at the moment of the abnormal power failure may be determined. When the value of the low-level formatting state at the moment of the abnormal power failure indicates that the log manager module is executing or completing the low-level formatting flow, the log manager module does not continue to complete the low-level formatting flow corresponding to the log manager module. During the process of powering on the solid-state drive and executing driver loading by the solid-state drive, when the saved value of the low-level formatting state indicates that the log manager module is executing or completing the low-level formatting flow, the log manager module does not continue to complete the low-level formatting flow corresponding to the log manager module. In some embodiments, since the metadata such as the L2P table and the trim table in the cache will not be restored, and the data manager module does not need to delete the metadata in the follow-up, this will reduce the recovery time of the power on process, the saved time may be used for the write manager module to execute the low-level formatting flow during the driver loading process, and further enabling the solid-state drive to exhibit an effect produced by the low-level formatting directly after being powered on and executing the driver loading, thereby improving the read and write performance of the solid-state drive.

In some embodiments, the method further includes:
creating a first block before the solid-state drive executes the low-level formatting; and
listing and saving values of a plurality of low-level formatting states included in the low-level formatting flow in the first block, wherein a value of each of the plurality of low-level formatting states is used to indicate a processing state of the modules during recording and executing the low-level formatting flow.

In the embodiments of the present application, before executing the low-level formatting by the solid-state drive, a first block (such as a Super Block) needs to be created in the computer flash memory device of the solid-state drive. The first block will not be cleared during the low-level formatting process, and is managed by a control manager module. The values of the plurality of low-level formatting states are listed in the first block to indicate which step of the low-level formatting flow is in.

Through the above embodiments, it may conveniently list and save the low-level formatting states corresponding to different steps of the low-level formatting flow in the first block before executing the low-level formatting, and store them in the computer flash memory device of the solid-state drive. This facilitates the various modules to read the values of the low-level formatting in the first block when it is powered on again after the abnormal power failure, and to determine which step the low-level formatting is in when the abnormal power failure occurs.

In some embodiments, the values of the plurality of low-level formatting states are configured to indicate any one of the following states: a low-level formatting idle state, a state of erasing information related to a L2P table and a trim table in a first-level table, a completion state of erasing the information related to the L2P table and the trim table in the first-level table, a state of saving the first-level table, a completion state of saving the first-level table, a state of erasing a target block, a completion state of erasing the target block, a state of erasing the L2P table and the trim table, a completion state of erasing the L2P table and the trim table, a low-level formatting completed state.

In the embodiments of the present application, the values of the plurality of low-level formatting states are configured to indicate any one of the following states: the low-level formatting idle state, the state of erasing information related to the L2P table and the trim table in the first-level table, the completion state of erasing the information related to the L2P table and the trim table in the first-level table, the state of saving the first-level table, the completion state of saving the first-level table, the state of erasing the target block, the completion state of erasing the target block, the state of erasing the L2P table and the trim table, the completion state of erasing the L2P table and the trim table, the low-level formatting completed state.

In some embodiments, when listing the plurality of low-level formatting states, typedef keywords may be used to list the values corresponding to the plurality of low-level formatting states, in order to record the state nodes of low-level formatting at different steps. The typedef keywords are as follows:

```
typedef enum format_process_state_enum {
  FORMAT_IDLE = 0;
  ERASE_L2P_AND_TRIM_FIRST_TABLE_ING;
  ERASE_L2P_AND_TRIM_FIRST_TABLE_CPL;
  SAVE_ALL_FIRST_TABLE_ING;
  SAVE_ALL_FIRST_TABLE_CPL;
  ERASE_TIC_SUPER_BLOCK_ING;
  ERASE_TIC_SUPER_BLOCK_CPL;
  ERASE_L2P_AND_TRIM_TABLE_ING;
  ERASE_L2P_AND_TRIM_TABLE_CPL;
  FORMAT_CPL;
  } format_process_state_e;
```

Among them, format_process_state represents the low-level formatting state, and the values in “{ }” represent different values of the low-level formatting states, the value of each low-level formatting state is used to indicate the processing state of the modules during recording and executing the low-level formatting flow, including the following values:
FORMAT_IDLE=0 indicates the low-level formatting idle state;
ERASE_L2P_AND_TRIM_FIRST_TABLE_ING indicates the state of erasing the information related to the L2P table and the trim table in the first-level table;
ERASE_L2P_AND_TRIM_FIRST_TABLE_CPL indicates the completion state of erasing the information related to the L2P table and the trim table in the first-level table;
SAVE_ALL_FIRST_TABLE_ING indicates the state of saving the first-level table;
SAVE_ALL_FIRST_TABLE_CPL indicates the completion state of saving the first-level table.

The above four low-level formatting states represent the steps executed by the log manager module.

ERASE_TIC_SUPER_BLOCK_ING indicates the state of erasing the target block, among them, the target block is each block including the user data in the computer flash memory device;

ERASE_TIC_SUPER_BLOCK_CPL indicates the completion state of erasing the target block.

The above two low-level formatting states represent the steps executed by the write manager module.

ERASE_L2P_AND_TRIM_TABLE_ING indicates the state of erasing the L2P table and the trim table;

ERASE_L2P_AND_TRIM_TABLE_CPL indicates the completion state of erasing the L2P table and the trim table.

The above two low-level formatting states represent the steps executed by the data manager module.

Through the above embodiments, by listing the various states and their corresponding values included in the low-level formatting flow in the first block in advance, it is convenient for the various modules to read the values of the low-level formatting in the first block when it is powered on again after the abnormal power failure, and to know which step the low-level formatting is in when the abnormal power failure occurs.

In some embodiments, the solid-state drive at least includes the log manager module, the write manager module, and the data manager module, and before step S103, the method further includes:
during the process of executing the driver loading by the solid-state drive, determining, by each module, whether to continue to complete a process of low-level formatting corresponding to each module based on the value of the low-level formatting state, to enable the solid-state drive to exhibit an effect produced by the low-level formatting;
in response to the value of the low-level formatting state at the moment of the abnormal power failure indicating that: the write manager module is executing or completing the low-level formatting flow, continuing to complete the low-level formatting flow corresponding to the write manager module; and
in response to the value of the low-level formatting state at the moment of the abnormal power failure indicating that: the data manager module is executing or completing the low-level formatting flow, not continuing to complete the low-level formatting flow corresponding to the data manager module.

In the embodiments of the present application, during the process of executing the driver loading by the solid-state drive, due to the different power on sequences of the various modules, the various modules will sequentially detect the value of the low-level formatting state in the first block. Based on the value of the low-level formatting state at the moment of the abnormal power failure, it is determined whether to continue to complete the low-level formatting steps corresponding to the various modules, so that the solid-state drive exhibits the effect produced by the low-level formatting.

Among them, there are two manifestations of the low-level formatting effect in the embodiments of the present application: the first is achieved by the data manager module and the write manager module. When the user reads data from the computer flash memory device, due to the low-level formatting process executed by the data manager module, the metadata in the L2P table and other caches is cleared, resulting in empty data being returned to the user. The second is achieved by the log manager module, if there is the abnormal power failure and powered on again during the low-level formatting process, the L2P table will still be empty because the metadata recovery process after being powered on again will not be executed. At this time, when the user accesses the computer flash memory device, the data returned to the user is also empty.

When the value of the low-level formatting state at the moment of the abnormal power failure indicates that: the write manager module is executing or completing the low-level formatting flow, it continues to complete the low-level formatting flow corresponding to the write manager module, including clearing the user data from computer flash memory devices.

When the value of the low-level formatting state at the moment of the abnormal power failure indicates that: the data manager module is executing or completing the low-level formatting flow, because the metadata such as the L2P table and the trim table included in the cache have been cleared when the abnormal power failure occurs, it does not continue to complete the low-level formatting flow corresponding to the data manager module.

Through the above embodiments, when the solid-state drive is powered on again after the abnormal power failure, the various modules of the solid-state drive may sequentially detect the values of the low-level formatting states at the moment of the abnormal power failure in the order of power on, and determine which step of the low-level formatting flow is in based on the values of the low-level formatting states at the moment of the abnormal power failure. According to different execution steps, it is determined whether to execute the low-level formatting flow corresponding to each module, so as to flexibly continue to execute the low-level formatting flow.

In some embodiments, step 103 includes:
by the log manager module, receiving a request to execute the driver loading and detecting the value of the low-level formatting state in the low-level formatting flow;
in response to detecting that the value of the low-level formatting state in the low-level formatting flow at the moment of the abnormal power failure indicates: the state of erasing the information related to the L2P table and the trim table in the first-level table or the state of saving the first-level table, not executing a process of restoring the L2P table and the trim table in a power on recovery process of the solid-state drive, normally executing driver loading of the log manager module, setting the value of the low-level formatting state to indicate the completion state of saving the first-level table, and feeding back formatting completion information of the log manager module to a write manager module of the solid-state drive, so that the write manager module of the solid-state drive continues to complete a corresponding low-level formatting process thereof, to enable the solid-state drive to exhibit an effect produced by the low-level formatting; and
in response to detecting that the value of the low-level formatting state in the low-level formatting flow at the moment of the abnormal power failure indicates: other states except for the completion state of erasing the information related to the L2P table and the trim table in the first-level table or the completion state of saving the first-level table, normally executing the driver loading of the log manager module, and directly feeding back the formatting completion information of the log manager module to the write manager module of the solid-state drive, so that the write manager module of the solid-state drive continues to complete the corresponding low-level formatting process thereof, to enable the solid-state drive to exhibit the effect produced by the low-level formatting.

In the embodiments of the present application, when the log manager module is powered on again after the abnormal power failure, the log manager module receives the request to execute the driver loading and detects the value of the low-level formatting state in the low-level formatting flow. When it is detected that the value of the low-level formatting state in the low-level formatting flow at the moment of the abnormal power failure indicates: the state of erasing the information related to the L2P table and the trim table in the first-level table or the state of saving the first-level table. That is, when the value of the low-level formatting state at the moment of the abnormal power failure is ERASE_L2P_AND_TRIM_FIRST_TABLE_ING or SAVE_ALL_FIRTS_TABLE_ING, it indicates that the log manager module is executing the steps corresponding to the log manager module in the low-level formatting flow when the abnormal power failure occurs. However, after the abnormal power failure, the metadata in the cache is cleared, so after powering on again, the process of restoring the L2P table and the trim table in the power on recovery process of the solid-state drive is no longer executed, the driver loading of the log manager module is executed normally, the value of the low-level formatting state is set to indicate the completion state of saving the first-level table, namely SAVE_ALL_FIRTS_TABLE_CPL, and the formatting completion information of the log manager module is fed back to the write manager module of the solid-state drive. Among them, the formatting completion information of the log manager module indicates that the log manager module has completed the steps corresponding to the log manager module in the low-level formatting flow, so that the write manager module of the solid-state drive continues to complete the corresponding low-level formatting process thereof, to enable the solid-state drive to exhibit the effect produced by the low-level formatting.

When the log manager module detects that the value of the low-level formatting state in the low-level formatting flow at the moment of the abnormal power failure indicates: other states except for the completion state of erasing the information related to the L2P table and the trim table in the first-level table or the completion state of saving the first-level table, that is, other values except for ERASE_L2P_AND_TRIM_FIRST_TABLE_CPL or SAVE_ALL_FIRST_TABLE_CPL, the driver loading of the log manager module is executed normally, and the formatting completion information of the log manager module is directly fed back to the write manager module of the solid-state drive, so that the write manager module of the solid-state drive continues to complete the corresponding low-level formatting process thereof, to enable the solid-state drive to exhibit the effect produced by the low-level formatting.

Through the above embodiments, when the log manager module is powered on again after the abnormal power failure, during the process of executing the driver loading by the log manager module, it is determined whether to directly feedback the formatting completion information of the log manager module or feedback the formatting completion information of the log manager module after setting the value of the low-level formatting state to indicate the completion state of saving the first level table based on the saved value of the low-level formatting state in the low-level formatting flow at the moment of the abnormal power failure. However, in either case, after powering on again, the log manager module will not continue to complete the steps corresponding to the log manager module in the low-level formatting flow, thereby reducing the recovery time of the power on process, the saved time may be used for the write manager module to execute the low-level formatting flow during the driver loading process, and further enabling the solid-state drive to exhibit the effect produced by the low-level formatting directly after being powered on and executing the driver loading, thereby improving the read and write performance of the solid-state drive.

It should be noted that after powering on again, the log manager module cannot restore the operation of erasing the L2P table and trim table type JM_L2P, as well as programing the entire first-level table. One reason is that the log manager module has not yet rebuilt the management data structure of each block (SLC block) of the computer flash memory device, so it has not opened an open block. More importantly, even if the open block is opened, because the SLC block is flushed down, it will cause changes in the metadata such as block occupancy state information (SLC block info). However, if the abnormal power failure occurs, even if the emergency exit is completed and the front-end is returned with power on completion, the host may not have received the driver loading request and does not initiate the power down process, and the capacitor has been depleted. This may lead to the risk of block (SLC block) duplication when powered on again.

In some embodiments, after feeding back the formatting completion information of the log manager module to the write manager module of the solid-state drive, the method further includes:
by the write manager module, receiving the formatting completion information of the log manager module feedback from the log manager module;
detecting the value of the low-level formatting state in the low-level formatting flow at the moment of the abnormal power failure;
in response to detecting that the value of the low-level formatting state in the low-level formatting flow at the moment of the abnormal power failure indicates: the completion state of saving the first-level table or the state of erasing the target block, erasing the target block in the solid-state drive, and resetting metadata related to the target block;
updating the value of the low-level formatting state to indicate the completion state of erasing the target block, feeding back formatting completion information of the write manager module to a data manager module of the solid-state drive; and
in response to detecting that the value of the low-level formatting state in the low-level formatting flow at the moment of the abnormal power failure indicates: other states except for the completion state of saving the first-level table or the state of erasing the target block, normally executing driver loading of the write manager module, and feeding back the formatting completion information of the write manager module to the data manager module of the solid-state drive.

In the embodiments of the present application, when the log manager module completes the execution of the corresponding driver loading, the write manager module receives the formatting completion information of the log manager module feedback from the log manager module. At this time, the write manager module begins to execute the driver loading process. During the driver loading process, the value of the low-level formatting state in the low-level formatting flow at the moment of the abnormal power failure is detected. When it is detected that the value of the low-level formatting state in the low-level formatting flow at the moment of the abnormal power failure indicates: the completion state of saving the first-level table or the state of erasing the target block, that is, when the value of the low-level formatting state at the moment of the abnormal power failure is SAVE_ALL_FIRST_TABLE_CPL or ERASE_TLC_SUPER_BLOCK_ING, it indicates that at the moment of the abnormal power failure, the write manager module is executing the corresponding steps in the low-level formatting flow, but has not completed them. Therefore, during the driver loading process after powering on again, the target block in the solid-state drive is erased, and the metadata related to the target block (such as block info) is reset. After the low-level formatting corresponding to the write manager module is completely executed, the value of the low-level formatting state is updated to indicate the completion state of erasing the target block, and the formatting completion information of the write manager module is fed back to the data manager module of the solid-state drive.

When the write manager module detects that the value of the low-level formatting state in the low-level formatting flow at the moment of the abnormal power failure indicates: other states except for the completion state of saving the first-level table or the state of erasing the target block, it indicates that the write manager module has completed the steps corresponding to the write manager module in the low-level formatting flow before the abnormal power failure. After powering on again, the driver loading of the write manager module is executed normally, and the formatting completion information of the write manager module is directly fed back to the data manager module of the solid-state drive.

Through the above embodiments, during the driver loading process when the write manager module is powered on again after the abnormal power failure, it may enable the write manager module to determine whether to continue to complete the steps corresponding to the write manager module in the low-level formatting flow during the driver loading process based on the value of the low-level formatting state at the moment of the abnormal power failure. Thus, there is no need to re-execute the low-level formatting flow, thereby improving the processing efficiency of continuing to execute the low-level formatting flow when encountering the abnormal power failure.

In some embodiments, after feeding back the formatting completion information of the write manager module to the data manager module of the solid-state drive, the method further includes:
by the data manager module, receiving the formatting completion information of the write manager module feedback from the write manager module, and detecting the value of the low-level formatting state in the low-level formatting flow at the moment of the abnormal power failure;
in response to detecting that the value of the low-level formatting state in the low-level formatting flow at the moment of the abnormal power failure indicates: the state of erasing the L2P table and the trim table, the completion state of erasing the L2P table and the trim table, the low-level formatting completed state or the completion state of erasing the target block, updating the value of the low-level formatting state to indicate the low-level formatting idle state, normally executing driver loading of the data manager module, and feeding back formatting completion information of the data manager module to a host.

In the embodiments of the present application, when the write manager module completes the execution of the corresponding driver loading, the data manager module receives the formatting completion information of the write manager module feedback from the write manager module. At this time, the data manager module begins to execute the driver loading process. During the driver loading process, the value of the low-level formatting state in the low-level formatting flow at the moment of the abnormal power failure is detected. When the data manager module detects that the value of the low-level formatting state in the low-level formatting flow at the moment of the abnormal power failure indicates: the state of erasing the L2P table and the trim table, the completion state of erasing the L2P table and the trim table, the low-level formatting completed state or the completion state of erasing the target block, that is, ERASE_L2P_AND_TRIM_TABLE_ING or FORMAT_CPL or ERASE_TLC_SUPER_BLOCK_CPL. At this point, it indicates that all steps corresponding to the low-level formatting flow have been completely executed. At this point, the data manager module updates the value of the low-level formatting state to indicate the low-level formatting idle state, that is, FORMAT_IDLE, and normally executes the driver loading of the data manager module, and feeds back the formatting completion information of the data manager module to the host.

Through the above embodiments, during the driver loading process, the data manager module may determine whether the low-level formatting flow before the abnormal power failure is completed based on the value of the low-level formatting state at the moment of the abnormal power failure. After determining that the low-level formatting flow has been completed, the value of the low-level formatting state is updated and fed back to the host, to improve the processing efficiency of the low-level formatting when encountering the abnormal power failure.

In some embodiments, the method further includes:
after the host receives the formatting completion information of the data manager module, determining that the low-level formatting is completed;
in response to the solid-state drive experiencing no abnormal power failure, completing the effect of the low-level formatting by the data manager module and the write manager module;
in response to the solid-state drive experiencing the abnormal power failure and is powered on again, completing the effect of the low-level formatting by the log manager module.

In the embodiment of the present application, after the host receives the formatting completion information of the data manager module, it may confirm that all steps of the low-level formatting flow of the solid-state drive have been completed. At this time, it needs to further demonstrate the effect of the low-level formatting. In the embodiment of the present application, the manifestation of the effect of the low-level formatting may be divided into two situations:

When there is no abnormal power failure in the solid-state drive, the effect of the low-level formatting is completed by the data manager module and the write manager module. When the user reads data from the solid-state drive, the metadata in the cache of the solid-state drive and the user data stored in the computer flash memory device have been cleared, so the data returned to the user is empty.

When the solid-state drive experiences the abnormal power failure and is powered on again, the effect of the low-level formatting is completed by the log manager module. When the user reads the data from the solid-state drive, the metadata in the cache of the solid-state drive has been cleared. At this time, although the user data stored in the backend computer flash memory device exists, since the metadata has been cleared, the data returned to the user is also empty.

Through the above embodiments, it may achieve manifestations of different low-level formatting effects based on whether there is the abnormal power failure during the low-level formatting process after the low-level formatting is completed.

In some embodiments, step S101 includes:
updating the value of the low-level formatting state in real-time during the process of executing the low-level formatting by each module of the solid-state drive;
in response to the abnormal power failure occurring during the process of executing the low-level formatting, saving a latest updated value of the low-level formatting state in the solid-state drive.

In the embodiments of the present application, during the process of executing the low-level formatting by the various modules of the solid-state drive, regardless of whether there is the abnormal power failure, each module needs to update the value of the low-level formatting state in the first block in real time when completing or executing the corresponding steps in the low-level formatting flow, and save the latest updated value of the low-level formatting state in the solid-state drive when there is the abnormal power failure during the process of executing the low-level formatting.

Through the above embodiments, when each model completes or is executing the corresponding steps in the low-level formatting flow, the values of the low-level formatting states are updated, making it easier to quickly obtain the progress of the low-level formatting process before abnormal power failure in the future, and to continue to execute the low-level formatting flow based on the values of the low-level formatting states.

In some embodiments, the method further includes:
adding detection of the abnormal power failure in response to each module of the solid-state drive executing the low-level formatting flow;
in response to the abnormal power failure occurring, exiting, by each module, the low-level formatting flow currently being processed, and executing power down process of the solid-state drive.

In the embodiments of the present application, the detection of the abnormal power failure is added when each module of the solid-state drive executes the low-level formatting flow. When the abnormal power failure occurs, each module exits the low-level formatting flow currently being processed, saves the value of the low-level formatting state at the moment of the abnormal power failure, and executes the power down process of the solid-state drive.

Through the above embodiments, it may detect whether there is the abnormal power failure in real-time during the process of executing the low-level formatting by the solid-state drive. Therefore, when the abnormal power failure occurs, the value of the low-level formatting state at the moment of the abnormal power failure may be urgently saved, and the power down process of the solid-state drive may be executed. This allows the low-level formatting flow to continue based on the values of the low-level formatting states after powering on again.

In some embodiments, in response to the abnormal power failure occurring during the process of executing the low-level formatting by the solid-state drive, saving the value of the low-level formatting state in the low-level formatting flow at the moment of the abnormal power failure, includes:
calling a built-in energy-storage capacitor in the solid-state drive;
in response to the built-in energy-storage capacitor supplying power to the solid-state drive, programming the value of the low-level formatting state in the low-level formatting flow at the moment of the abnormal power failure into a computer flash memory device of the solid-state drive.

In some embodiments, when the abnormal power failure occurs during the process of executing the low-level formatting by the solid-state drive, it needs to immediately save the value of the low-level formatting state in the low-level formatting flow at the moment of the abnormal power failure during the power down process of the abnormal power failure. In this regard, the step of saving may be added to the power down process, and the built-in energy storage capacitor in the solid-state drive may be called to supply power to the power down process of the abnormal power failure. When the energy storage capacitor supplies power to the solid-state drive, the value of the low-level formatting state in the low-level formatting flow at the moment of the abnormal power failure may be programed into the computer flash memory device of the solid-state drive.

Through the above embodiments, the steps corresponding to saving the value of the low-level formatting state in the low-level formatting flow at the moment of the abnormal power failure may be added to the power down process, and the energy storage capacitor in the solid-state drive may supply power to the power down process, so that when powered on again in the future, the various modules of the solid-state drive may read and detect the value of the low-level formatting state in the low-level formatting flow at the moment of the abnormal power failure.

In some embodiments, in the embodiment of the present application, in order to more accurately record the execution status of the low-level formatting flow during the abnormal power failure, the first block may configure a first value, a second value and a third value at the moment of the abnormal power failure in the low-level formatting flow during the process of erasing the user data in the computer flash memory device of the solid-state drive by the write manager module. The first value may be used to record the latest erase location of the write manager module during the process of erasing the user data in the computer flash memory device of the solid-state drive, the second value may be used to record the number of user data that has not been erased during the process of erasing the user data in the computer flash memory device of the solid-state drive by the write manager module, and the third value may be used to record the location of the user data that has not been erased during the process of erasing the user data in the computer flash memory device of the solid-state drive by the write manager module. This allows the write manager module to quickly obtain the execution status of the low-level formatting flow before the abnormal power failure based on the first value, the second value, and the third value when powering on again after the abnormal power failure, thereby improving the efficiency of the low-level formatting flow after the driver loading is completed.

In some embodiments, in the embodiments of the present application, if the abnormal power failure occurs again during the process of executing the low-level formatting when powered on again after the abnormal power failure, the processing of the abnormal power failure shall be the same as the above processing flow.

In summary, due to the need to be restored to the effect produced by the low-level formatting after the abnormal power failure and power on again, the log manager module will not restore the metadata such as the L2P table and the trim table, which will save several seconds of recovery time when powering on again (for example, an 8T drive may save at least 4s of recovery time, and a large capacity drive will be even longer), and the tolerance time for the driver loading is at least 60s. Therefore, it is advisable to continue to execute the low-level formatting flow during the driver loading. If the abnormal power failure occurs during the recovery of the low-level formatting process, the flow will continue based on the value of the low-level formatting state at the moment of the abnormal power failure after the next power on. After the driver loading is completed, the read and write process of the solid-state drive may achieve the best performance after the low-level formatting flow.

FIG. 3 is a schematic diagram of a framework of an apparatus for processing an abnormal power failure according to some embodiments of the present application, as shown in FIG. 3, the embodiment provides an apparatus for processing an abnormal power failure, which includes:
a save module 11 configured for, in response to the abnormal power failure occurring during a process of executing low-level formatting by a solid-state drive, saving a value of a low-level formatting state in a low-level formatting flow at a moment of the abnormal power failure;
a detection module 12 configured for, during a process of powering on the solid-state drive and executing driver loading by the solid-state drive, detecting the value of the low-level formatting state by each module of the solid-state drive;
a first execution module 13 configured for, in response to the value of the low-level formatting state at the moment of the abnormal power failure indicating that: a log manager module is executing or completing the low-level formatting flow, not continuing to complete the low-level formatting flow corresponding to the log manager module.

In some embodiments, the apparatus further includes:
a creation module, configured for creating a first block before the solid-state drive executes the low-level formatting; and
a listing module, configured for listing and saving values of a plurality of low-level formatting states included in the low-level formatting flow in the first block, wherein a value of each of the plurality of low-level formatting states is configured to indicate a processing state of each module during recording and executing the low-level formatting flow.

The values of the plurality of low-level formatting states are configured to indicate any one of the following states: the low-level formatting idle state, the state of erasing information related to the L2P table and the trim table in the first-level table, the completion state of erasing the information related to the L2P table and the trim table in the first-level table, the state of saving the first-level table, the completion state of saving the first-level table, the state of erasing the target block, the completion state of erasing the target block, the state of erasing the L2P table and the trim table, the completion state of erasing the L2P table and the trim table, the low-level formatting completed state.

In some embodiments, the solid-state drive at least includes the log manager module, the write manager module, and the data manager module; and the apparatus further includes:
a determination module configured for, during the process of executing the driver loading by the solid-state drive, determining, by each module, whether to continue to complete a process of low-level formatting corresponding to each module based on the value of the low-level formatting state, to enable the solid-state drive to exhibit an effect produced by the low-level formatting;
a second execution module configured for, in response to the value of the low-level formatting state at the moment of the abnormal power failure indicating that: the write manager module is executing or completing the low-level formatting flow, continuing to complete the low-level formatting flow corresponding to the write manager module; and
a third execution module configured for, in response to the value of the low-level formatting state at the moment of the abnormal power failure indicating that: the data manager module is executing or completing the low-level formatting flow, not continuing to complete the low-level formatting flow corresponding to the data manager module.

In some embodiments, the first execution module 13 includes:
a first detection unit configured for receiving a request to execute the driver loading by the log manager module and detecting the value of the low-level formatting state in the low-level formatting flow;
a first execution unit configured for, in response to detecting that the value of the low-level formatting state in the low-level formatting flow at the moment of the abnormal power failure indicates: the state of erasing the information related to the L2P table and the trim table in the first-level table or the state of saving the first-level table, not executing a process of restoring the L2P table and the trim table in a power on recovery process of the solid-state drive, normally executing driver loading of the log manager module, setting the value of the low-level formatting state to indicate the completion state of saving the first-level table, and feeding back formatting completion information of the log manager module to a write manager module of the solid-state drive, so that the write manager module of the solid-state drive continues to complete a corresponding low-level formatting process thereof, to enable the solid-state drive to exhibit an effect produced by the low-level formatting;
a second execution unit configured for, in response to detecting that the value of the low-level formatting state in the low-level formatting flow at the moment of the abnormal power failure indicates: other states except for the completion state of erasing the information related to the L2P table and the trim table in the first-level table or the completion state of saving the first-level table, normally executing the driver loading of the log manager module, and directly feeding back the formatting completion information of the log manager module to the write manager module of the solid-state drive, so that the write manager module of the solid-state drive continues to complete the corresponding low-level formatting process thereof, to enable the solid-state drive to exhibit the effect produced by the low-level formatting.

In some embodiments, the apparatus further includes:
a receiving module, configured for receiving the formatting completion information of the log manager module feedback from the log manager module by the write manager module after feeding back the formatting completion information of the log manager module to the write manager module of the solid-state drive;
a second detection unit, configured for detecting the value of the low-level formatting state in the low-level formatting flow at the moment of the abnormal power failure;
a third execution unit configured for, in response to detecting that the value of the low-level formatting state in the low-level formatting flow at the moment of the abnormal power failure indicates: the completion state of saving the first-level table or the state of erasing the target block, erasing the target block in the solid-state drive, and resetting metadata related to the target block;
a first update unit, configured for updating the value of the low-level formatting state to indicate the completion state of erasing the target block, feeding back formatting completion information of the write manager module to a data manager module of the solid-state drive;
a fourth execution unit configured for, in response to detecting that the value of the low-level formatting state in the low-level formatting flow at the moment of the abnormal power failure indicates: other states except for the completion state of saving the first-level table or the state of erasing the target block, normally executing driver loading of the write manager module, and feeding back the formatting completion information of the write manager module to the data manager module of the solid-state drive.

In some embodiments, the apparatus further includes:
a third detection unit configured for receiving the formatting completion information of the write manager module feedback from the write manager module by the data manager module after feeding back the formatting completion information of the write manager module to the data manager module of the solid-state drive, and detecting the value of the low-level formatting state in the low-level formatting flow at the moment of the abnormal power failure;
a fifth execution unit configured for, in response to detecting that the value of the low-level formatting state in the low-level formatting flow at the moment of the abnormal power failure indicates: the state of erasing the L2P table and the trim table, the completion state of erasing the L2P table and the trim table, the low-level formatting completed state or the completion state of erasing the target block, updating the value of the low-level formatting state to indicate the low-level formatting idle state, normally executing driver loading of the data manager module, and feeding back formatting completion information of the data manager module to a host.

In some embodiments, the apparatus further includes:
a determination unit configured for, after the host receives the formatting completion information of the data manager module, determining that the low-level formatting is completed;
a first low-level formatting effect completion unit configured for, in response to the solid-state drive experiencing no abnormal power failure, completing the effect of the low-level formatting by the data manager module and the write manager module;
a second low-level formatting effect completion unit configured for, in response to the solid-state drive experiencing the abnormal power failure and is powered on again, completing the effect of the low-level formatting by the log manager module.

In some embodiments, the save module 11 includes:
a second update unit, configured for updating the value of the low-level formatting state in real-time during the process of executing the low-level formatting by each module of the solid-state drive;
a save unit configured for, in response to the abnormal power failure occurring during the process of executing the low-level formatting, saving a latest updated value of the low-level formatting state in the solid-state drive.

In some embodiments, the apparatus further includes:
a fourth detection unit, configured for adding detection of the abnormal power failure in response to each module of the solid-state drive executing the low-level formatting flow;
a sixth execution unit configured for, in response to the abnormal power failure occurring, exiting, by each module, the low-level formatting flow currently being processed, and executing power down process of the solid-state drive.

In some embodiments, the save module 11 includes:
a calling module, configured for calling a built-in energy-storage capacitor in the solid-state drive;
a programming module configured for, in response to the built-in energy-storage capacitor supplying power to the solid-state drive, programming the value of the low-level formatting state in the low-level formatting flow at the moment of the abnormal power failure into a computer flash memory device of the solid-state drive.

Based on the same inventive concept, other embodiments of the present application also provide an electronic device including a memory, a processor, and a computer program stored on the memory, wherein the processor executes the computer program to implement the method for processing the abnormal power failure as described in any of the above embodiments.

Based on the same inventive concept, other embodiments of the present application also provide a computer program product, including a computer program, wherein the computer program, when executed by a processor, implements the method for processing the abnormal power failure as described in any of the above embodiments.

Based on the same inventive concept, other embodiments of the present application also provide a non-transitory computer-readable medium, a computer program is stored thereon, wherein the program, when executed by a processor, implements the method for processing the abnormal power failure as described in any of the above embodiments.

For the device, due to its basic similarity with the method embodiments, the description is relatively simple. For relevant information, please refer to the partial explanation of the method embodiments.

The various embodiments in this specification are described in a progressive manner, with each embodiment emphasizing its differences from other embodiments. The same and similar parts between the various embodiments may be referred to each other.

Persons skilled in the art should understand that the embodiments of the present application may be provided as methods, devices, or computer program products. Therefore, the embodiments of the present application may take the form of fully hardware embodiments, fully software embodiments, or embodiments combining software and hardware aspects. Moreover, the embodiments of the present application may take the form of a computer program product implemented on one or more computer usable storage media (including but not limited to disk storage, CD-ROM, optical storage, etc.) containing computer usable program code.

The embodiments of the present application are described with reference to the flowchart and/or block diagram of the method, terminal device (system), and computer program product according to the embodiments of the present application. It should be understood that each process and/or block in the flowchart and/or block diagram, as well as the combination of processes and/or blocks in the flowchart and/or block diagram, may be implemented by computer program instructions. These computer program instructions may be provided to a processor of a general-purpose computer, specialized computer, embedded processor, or other programmable data processing terminal device to generate a machine, such that the instructions executed by the processor of the computer or other programmable data processing terminal device generate a device for implementing the functions specified in one or more processes in the flowchart and/or one or more boxes in the block diagram.

These computer program instructions may also be stored in computer-readable memory that may guide a computer or other programmable data processing terminal device to operate in a specific manner, such that the instructions stored in the computer-readable memory generate a manufactured product including instruction devices that implement the functions specified in a flowchart or multiple flowcharts and/or a block diagram or multiple boxes.

These computer program instructions may also be loaded onto a computer or other programmable data processing terminal device, enabling a series of operational steps to be executed on the computer or other programmable terminal device to generate computer implemented processing. The instructions executed on the computer or other programmable terminal device provide steps for implementing the functions specified in one or more processes in the flowchart and/or one or more boxes in the block diagram.

Although preferred embodiments of the present application have been described, those skilled in the art may make additional changes and modifications to these embodiments once they have knowledge of the basic inventive concept Therefore, the attached claims are intended to be interpreted as including preferred embodiments and all changes and modifications falling within the scope of the embodiments of the present application.

Finally, it should be noted that in this specification, relational terms such as first and second are only used to distinguish one entity or operation from another, and do not necessarily require or imply any actual relationship or order between these entities or operations. Moreover, the terms “including/comprising”, “containing”, or any other variation thereof are intended to encompass non-exclusive inclusion, such that a process, method, article, or terminal device that includes a series of elements not only includes those elements, but also includes other elements not explicitly listed, or also includes elements inherent to such process, method, article, or terminal device. Without further limitations, the element limited by the statement “including one . . . ” does not exclude the existence of other identical elements in the process, method, item, or terminal device that includes the element.

The above provides a detailed introduction to the method and apparatus for processing the abnormal power failure, the device, the medium, and the product provided in the present application. Specific examples are applied in this specification to explain the principles and implementation methods of the present application. The above embodiments are only used to help understand the method and core idea of the present application. Meanwhile, for persons skilled in the art, there may be changes in the specific implementation and application scope based on the ideas of the present application. Therefore, the content of this specification should not be understood as limiting the present application.

1. A method for processing an abnormal power failure, comprising:
in response to the abnormal power failure occurring during a process of executing low-level formatting by a solid-state drive, saving a value of a low-level formatting state in a low-level formatting flow at a moment of the abnormal power failure;
during a process of powering on the solid-state drive and executing driver loading by the solid-state drive, detecting the value of the low-level formatting state by each module of the solid-state drive; and
in response to the value of the low-level formatting state at the moment of the abnormal power failure indicating that: a log manager module is executing or completing the low-level formatting flow, not continuing to complete the low-level formatting flow corresponding to the log manager module.

2. The method for processing the abnormal power failure according to claim 1, further comprising:
creating a first block before the solid-state drive executes the low-level formatting; and
listing and saving values of a plurality of low-level formatting states comprised in the low-level formatting flow in the first block, wherein a value of each of the plurality of low-level formatting states is configured to indicate a processing state of each module during recording and executing the low-level formatting flow.

3. The method for processing the abnormal power failure according to claim 2, wherein the values of the plurality of low-level formatting states are configured to indicate any one of the following states: a low-level initialization idle state, a state of erasing information related to a L2P table and a trim table in a first-level table, a completion state of erasing the information related to the L2P table and the trim table in the first-level table, a state of saving the first-level table, a completion state of saving the first-level table, a state of erasing a target block, a completion state of erasing the target block, a state of erasing the L2P table and the trim table, a completion state of erasing the L2P table and the trim table, a low-level initialization completed state.

4. The method for processing the abnormal power failure according to claim 1, wherein the solid-state drive at least comprises the log manager module, a write manager module, and a data manager module; before in response to the value of the low-level formatting state at the moment of the abnormal power failure indicating that: the log manager module is executing or completing the low-level formatting flow, not continuing to complete the low-level formatting flow corresponding to the log manager module, the method further comprises:
during the process of executing the driver loading by the solid-state drive, determining, by each module, whether to continue to complete a process of low-level formatting corresponding to each module based on the value of the low-level formatting state, to enable the solid-state drive to exhibit an effect produced by the low-level formatting;
in response to the value of the low-level formatting state at the moment of the abnormal power failure indicating that: the write manager module is executing or completing the low-level formatting flow, continuing to complete the low-level formatting flow corresponding to the write manager module; and
in response to the value of the low-level formatting state at the moment of the abnormal power failure indicating that: the data manager module is executing or completing the low-level formatting flow, not continuing to complete the low-level formatting flow corresponding to the data manager module.

5. The method for processing the abnormal power failure according to claim 3, wherein in response to the value of the low-level formatting state at the moment of the abnormal power failure indicating that: the log manager module is executing or completing the low-level formatting flow, not continuing to complete the low-level formatting flow corresponding to the log manager module, comprises:
by the log manager module, receiving a request to execute the driver loading and detecting the value of the low-level formatting state in the low-level formatting flow;
in response to detecting that the value of the low-level formatting state in the low-level formatting flow at the moment of the abnormal power failure indicates: the state of erasing the information related to the L2P table and the trim table in the first-level table or the state of saving the first-level table, not executing a process of restoring the L2P table and the trim table in a power on recovery process of the solid-state drive, normally executing driver loading of the log manager module, setting the value of the low-level formatting state to indicate the completion state of saving the first-level table, and feeding back formatting completion information of the log manager module to a write manager module of the solid-state drive, so that the write manager module of the solid-state drive continues to complete a corresponding low-level formatting process thereof, to enable the solid-state drive to exhibit an effect produced by the low-level formatting; and
in response to detecting that the value of the low-level formatting state in the low-level formatting flow at the moment of the abnormal power failure indicates: other states except for the completion state of erasing the information related to the L2P table and the trim table in the first-level table or the completion state of saving the first-level table, normally executing the driver loading of the log manager module, and directly feeding back the formatting completion information of the log manager module to the write manager module of the solid-state drive, so that the write manager module of the solid-state drive continues to complete the corresponding low-level formatting process thereof, to enable the solid-state drive to exhibit the effect produced by the low-level formatting.

6. The method for processing the abnormal power failure according to claim 5, wherein after feeding back the formatting completion information of the log manager module to the write manager module of the solid-state drive, the method further comprises:
by the write manager module, receiving the formatting completion information of the log manager module feedback from the log manager module;
detecting the value of the low-level formatting state in the low-level formatting flow at the moment of the abnormal power failure;
in response to detecting that the value of the low-level formatting state in the low-level formatting flow at the moment of the abnormal power failure indicates: the completion state of saving the first-level table or the state of erasing the target block, erasing the target block in the solid-state drive, and resetting metadata related to the target block;
updating the value of the low-level formatting state to indicate the completion state of erasing the target block, feeding back formatting completion information of the write manager module to a data manager module of the solid-state drive; and
in response to detecting that the value of the low-level formatting state in the low-level formatting flow at the moment of the abnormal power failure indicates: other states except for the completion state of saving the first-level table or the state of erasing the target block, normally executing driver loading of the write manager module, and feeding back the formatting completion information of the write manager module to the data manager module of the solid-state drive.

7. The method for processing the abnormal power failure according to claim 6, wherein after feeding back the formatting completion information of the write manager module to the data manager module of the solid-state drive, the method further comprises:
by the data manager module, receiving the formatting completion information of the write manager module feedback from the write manager module, and detecting the value of the low-level formatting state in the low-level formatting flow at the moment of the abnormal power failure; and
in response to detecting that the value of the low-level formatting state in the low-level formatting flow at the moment of the abnormal power failure indicates: the state of erasing the L2P table and the trim table, the completion state of erasing the L2P table and the trim table, the low-level initialization completed state or the completion state of erasing the target block, updating the value of the low-level formatting state to indicate the low-level formatting idle state, normally executing driver loading of the data manager module, and feeding back formatting completion information of the data manager module to a host.

8. The method for processing the abnormal power failure according to claim 7, further comprising:
after the host receives the formatting completion information of the data manager module, determining that the low-level formatting is completed;
in response to the solid-state drive experiencing no abnormal power failure, completing the effect of the low-level formatting by the data manager module and the write manager module; and
in response to the solid-state drive experiencing the abnormal power failure and is powered on again, completing the effect of the low-level formatting by the log manager module.

9. The method for processing the abnormal power failure according to claim 1, wherein in response to the abnormal power failure occurring during the process of executing the low-level formatting by the solid-state drive, saving the value of the low-level formatting state in the low-level formatting flow at the moment of the abnormal power failure, comprises:
updating the value of the low-level formatting state in real-time during the process of executing the low-level formatting by each module of the solid-state drive; and
in response to the abnormal power failure occurring during the process of executing the low-level formatting, saving a latest updated value of the low-level formatting state in the solid-state drive.

10. The method for processing the abnormal power failure according to claim 1, further comprising:
adding detection of the abnormal power failure in response to each module of the solid-state drive executing the low-level formatting flow; and
in response to the abnormal power failure occurring, exiting, by each module, the low-level formatting flow currently being processed, and executing power down process of the solid-state drive.

11. The method for processing the abnormal power failure according to claim 1, wherein in response to the abnormal power failure occurring during the process of executing the low-level formatting by the solid-state drive, saving the value of the low-level formatting state in the low-level formatting flow at the moment of the abnormal power failure, comprises:
calling a built-in energy-storage capacitor in the solid-state drive; and
in response to the built-in energy-storage capacitor supplying power to the solid-state drive, programming the value of the low-level formatting state in the low-level formatting flow at the moment of the abnormal power failure into a computer flash memory device of the solid-state drive.

12. The method for processing the abnormal power failure according to claim 4, wherein continuing to complete the low-level formatting flow corresponding to the write manager module comprises:
clearing user data from the computer flash memory device of the solid-state drive.

13. The method for processing the abnormal power failure according to claim 2, wherein the first block is not cleared during the process of executing the low-level formatting.

14. The method for processing the abnormal power failure according to claim 7, wherein low-level initialization idle, erasing information related to the L2P table and the trim table in the first-level table, the completion of erasing the information related to the L2P table and the trim table in the first-level table, saving the first-level table, and the completion of saving the first-level table represent steps executed by the log manager module.

15. The method for processing the abnormal power failure according to claim 7, wherein erasing the target block, and the completion of erasing the target block represent steps executed by the write manager module.

16. The method for processing the abnormal power failure according to claim 7, wherein erasing the L2P table and the trim table, and the completion of erasing the L2P table and the trim table represent steps executed by the data manager module.

17. (canceled)

18. An electronic device, comprising a memory, a processor, and a computer program stored on the memory, wherein the processor executes the computer program to implement the method for processing the abnormal power failure according to claim 1.

19. A computer program product, comprising a computer program, wherein the computer program, when executed by a processor, implements the method for processing the abnormal power failure according to claim 1.

20. A non-transitory computer-readable medium, storing a computer program thereon, wherein the computer program, when executed by a processor, implements the method for processing the abnormal power failure according to claim 1.

21. The method for processing the abnormal power failure according to claim 11, wherein the method further comprises:
after the value of the low-level formatting state is programed into the computer flash memory device, updating, by a write manager module, a cache entry index in a L2P table to an address of the computer flash memory device.
